(19) United States
(12) Patent Application Publication
(10) Pub. No.: US 2002/0181456 A1
(43) Pub. Date: Dec. 5, 2002

(54) Switch device and data transfer system

(75) Inventors: Tooru Katayama, Kawasaki (JP); Norio Abe, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/949,871

(22) Filed: Sep. 12, 2001

(30) Foreign Application Priority Data
May 31, 2001 (JP) 2001-165073

(51) Int. Cl. H04L 12/28; H04L 12/56

(52) U.S. Cl. 370/389

(57) ABSTRACT

A switch device includes ports, a switching part for switching data received via the ports in accordance with destinations of the data, a memory part for storing the data received via the ports, and an interface part for enabling access to the memory part from a processing device that is provided outside of the switch device and processes the data stored in the memory part.

### BACKGROUND OF THE INVENTION

(1) Field of the Invention

The present invention relates to switch devices and data transfer systems, and more particularly to a switch device performing a switching process for transferring data that is input via any of a plurality of ports to another port. Further, the present invention is concerned with a data transfer system including a switch device as described above and a processing device capable of processing data in a given manner as necessary.

(2) Description of the Related Art

Generally, the Internet is a typical broadband data communication system. In contrast, a LAN (Local Area Network) is known as a communication system primarily directed to a computer communication constructed in a narrow area such as a local area or an identical building. A typical example of the LAN is Ethernet (registered trademark).

When a plurality of terminals are connected to the LAN, networks can be connected via switch devices. A switch device has a role of transferring communication data coming from a network or an interface connected thereto (hereinafter such data is simply referred to as data) to another network or interface as necessary. Each communication terminal and switch device process data and access the network.

FIG. 17 is a diagram of a structure of a conventional switch device.

As shown in this figure, the conventional switch device is made up of a switching part 101, a central processing part 106, a main memory part 108, a DMAC (Dynamic Memory Access Controller) 109, and an internal bus 110.

A plurality of terminals and networks may be connected to the switching part 101, which executes a process of transferring data received via a port to another port. The switching part 101 transfers data to be processed by the central processing part 106 to a memory part 111b of the main memory part 108 in order to have the central processing part 106 process the data stored therein.

The central processing part 106 accesses the memory part 111b of the main memory part 108 via the internal bus 110, and processes the data stored therein in a given manner. The DMAC 109 transfers data between the switching part 101 and the main memory part 108, while the central processing part 106 is not involved with the data transfer. The main memory unit 108 is made up of a general-purpose memory I/F (Interface) 111a and the memory part 111b, and stores data that is an object of a program and a process executed by the main processing part 106.

FIG. 18 is a diagram of a detailed illustration of a structure of the switching part 101. As shown in this figure, the switching part 101 is made up of data sending/receiving parts 403a through 403n, a host I/F 405, a switch part 407, a control signal generating part 426, an internal bus 430, and a destination identifying part 440.

The data sending/receiving parts 403a through 403n are connected to NET#1 through NET#n, which are networks (or network devices), and send and receive data to and from the NET#1 through NET#n. The host I/F 405 is formed by a buffer as will be described later, and temporarily stores data when data is transferred with the main memory part 108. The switch part 407 transfers data to the data sending/receiving part or the host I/F 405 in accordance with the destination identified by the destination identifying part 440. The control signal generating part 426 generates a control signal that requests a data transfer to the DMAC 109 when receiving data addressed to the host I/F 405. The destination identifying part 440 refers to headers of data stored in the data sending/receiving parts 403a through 403n, and thus identifies the respective destinations of the data.

FIG. 19 is a diagram of a detained configuration of the host I/F 405. As shown in this figure, the host I/F 405 is made up of a sending buffer 524, a receiving buffer 525, and an input/output I/F 520.

The receiving buffer 525 temporarily stores data supplied from the switch part 407. The sending buffer 524 temporarily stores data transferred from the main memory part 108 under the control of the DMAC 109. The input/output I/F 520 provides an interface for a data transfer using the receiving buffer 525 or the sending buffer 524 via the DMAC 109.

Next, a description will be given of an operation of the conventional switch device. The following description is exemplarily directed to a case where data needed to be processed by the central processing part 106 is input from NET#1 and is then output to NET#3.

Data input from NET#1 shown in FIG. 18 is received by the data sending/receiving part 403a, and is temporarily stored therein.

The destination identifying part 440 refers to the header of the data stored in the data sending/receiving part 403a, and identifies the destination of the data. If it is determined that the data is addressed to the host I/F 405 (data to be processed by the central processing part 106), the destination identifying part 440 notifies the switch part 407 and the control signal generating part 426 of the above.

The switch part 407 executes a process of sending the data stored in the data sending/receiving part 403a to the host I/F 405. Thus, the data stored in the data sending/receiving part 403a is transferred to the host I/F 405 via the internal bus 430. The host I/F 405 receives the data via the receiving buffer 525, in which the data is temporarily stored.

As has been described previously, the control signal generating part 426 has been informed of the presence of data to be transferred to the main memory part 108. Therefore, the control signal generating part 426 requests the DMAC 109 to transfer data stored in the receiving buffer 525 to the main memory part 108. Responsive to the above request, the DMAC 109 reads the data stored in the receiving buffer 525, and transfers the read data to the memory part 111b of the main memory part 108.

The receiving buffer 525 is a memory of FIFO (First-In First-Out) type, in which and data is read in the order in which the data was stored.

Once the data is stored in the memory part 111b, the central processing part 106 accesses the part 111b via the internal bus 110, and refers to header information of the data. Then, the central processing part 106 performs a process, which may, for instance, be a header recalculation process or a discarding process.

When the process is completed, the central processing part 106 sends a transfer request to the DMAC 109. Then, the data that has been processed is transferred to the sending buffer 524 of the host I/F 405 by the DMAC 109.

The data stored in the sending buffer 524 is supplied to the data sending/receiving part 403c by the switch part 407, and is then sent to NET#3.

The above-mentioned process processes data input from NET#1 in a given manner and sends processed data to NET#3. The same process as described above is executed when data to be processed by the central processing part 106 is input from NET other than NET#1 and is output to NET other than NET#3.

In the above-mentioned prior art, data to be processed by the central processing part 106 is transferred to the main memory part 108 from the host I/F 405 by the DMAC 109, and is transferred from the main memory part 108 to the host I/F 405 by the DMAC 109 after the data is processed by the central processing part 106.

However, the above prior art has a disadvantage in that the internal bus 110 is occupied each time data is transferred. If another component needs to transfer data other than communication data (hereinafter referred to as ordinary data) via the internal bus 110, the ordinary data is transferred via the internal bus 110. For example, if ordinary data is assigned priority over communication data, the communication data may not be processed in time and may be delayed or lost.

In contrast, if communication data is assigned priority over ordinary data, there may be a difficulty in transfer of ordinary data, and a process other than data transfer may be delayed.

### SUMMARY OF THE INVENTION

Taking the above into consideration, an object of the present invention is to provide a packet switch apparatus capable of transferring data at high speed even when the data should be processed.

To accomplish the above object, according to the present invention, there is provided a switch device comprising: a plurality of ports for receiving and sending data; a switching part for switching data received via the plurality of ports in accordance with destinations of the data; a memory part for storing the data received via the plurality of ports; and an interface part for enabling enables access to the memory part from a processing device that is provided outside of the switch device and processes the data stored in the memory part.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a diagram of the principles of the present invention;

FIG. 2 is a block diagram of a structure of a system including a switch device according to an embodiment the present invention;

FIG. 3 is a block diagram of a typical example of the structure of the switch device shown in FIG. 2;

FIG. 4 is a block diagram of a typical example of the structure of a processing device shown in FIG. 3;

FIG. 5 is a block diagram of a typical example of the structure of a host I/F shown in FIG. 4;

FIG. 6 is a block diagram of a typical example of the structure of a general-purpose memory I/F shown in FIG. 5;

FIG. 7 is a flowchart of a receiving process of a conventional switch device shown in FIG. 17;

FIG. 8 is a flowchart of a sending process of the conventional switch device shown in FIG. 17;

FIG. 9 is a flowchart of a receiving process of the embodiment of the invention shown in FIG. 2;

FIG. 10 is a flowchart of a sending process of the embodiment of the invention shown in FIG. 2;

FIG. 11 is a block diagram of another structure of the host I/F shown in FIG. 4;

FIG. 12 is a block diagram of yet another structure of the host I/F shown in FIG. 4;

FIG. 13 is a block diagram of a further structure of the host I/F shown in FIG. 4;

FIG. 14 is a block diagram of a still further structure of the host I/F shown in FIG. 4;

FIG. 15 is a block diagram of another structure of the switch device of the present invention;

FIG. 16 is a block diagram of yet another structure of the switch device of the present invention;

FIG. 17 is a block diagram of a conventional switch device;

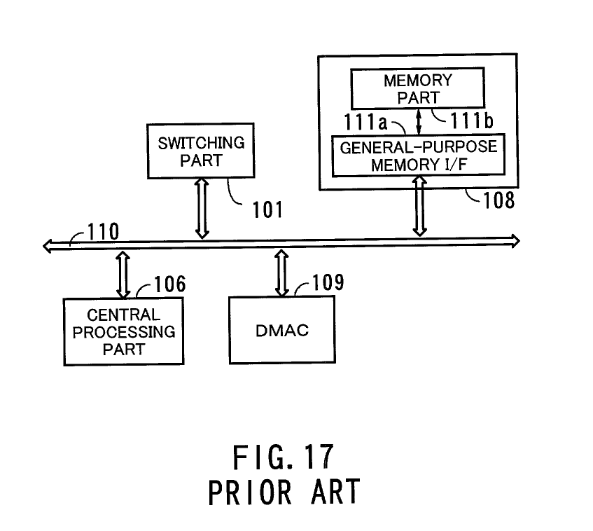

FIG. 18 is a block diagram of a detailed illustration of a switching part shown in FIG. 17; and

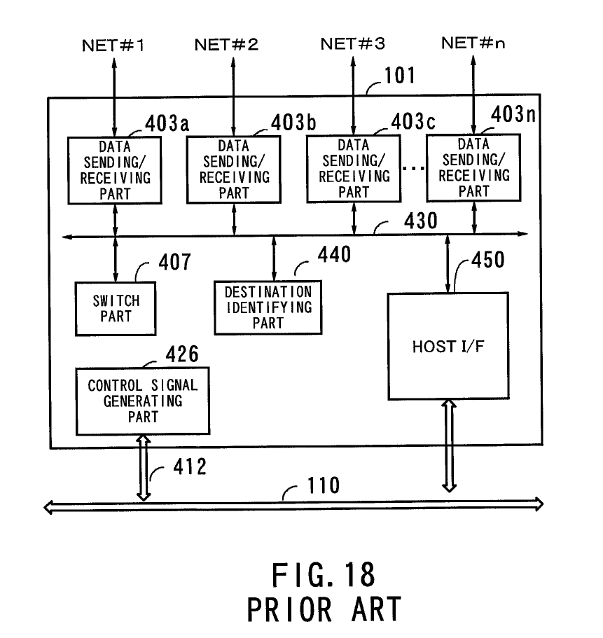

FIG. 19 is a block diagram of a typical example of the structure of a host I/F shown in FIG. 18.

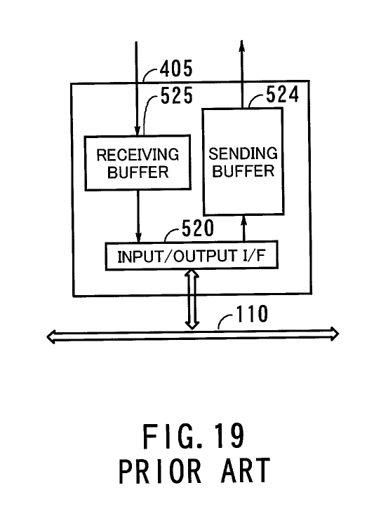

### DESCRIPTION OF THE PREFERRED EMBODIMENTS

Now, a description will be given of embodiments of the present invention with reference to the accompanying drawings.

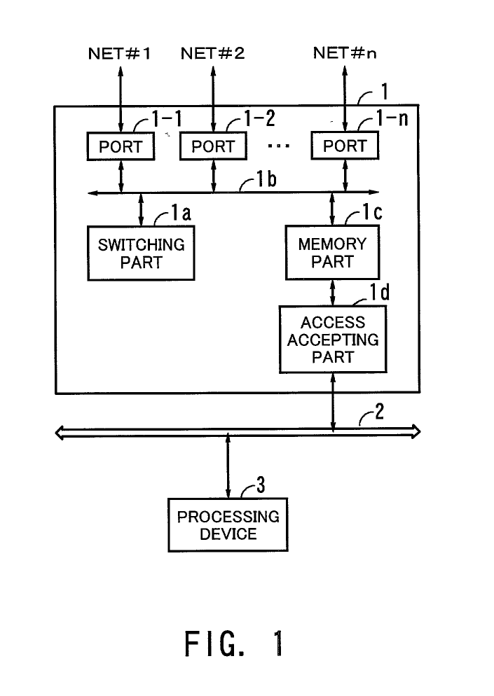

FIG. 1 is a diagram illustrating the principles of the present invention. A switch device 1 is made up of ports 1-1 through 1-n, a switching unit 1a, a bus 1b, a memory unit 1c, and an interface unit 1d. A processing device 3 is provided outside of the switch device 1 and is connected thereto via a bus 2, so that a data transfer system can be configured as a whole.

The ports 1-1 through 1-n are respectively connected to NET#1 through #n, which may be networks or network devices, and are used to transfer data between the switch device 1 and each NET. The switching unit 1a refers to the headers of data received via the ports 1-1 through 1-n and outputs the data to corresponding ports. Also, the switching unit 1a transfers data to be processed by the processing device 3 to the memory unit 1c. The bus 1b mutually connects the ports 1-1 through 1-n, the switching unit 1a and the memory unit 1c, and is used to transfer data. The memory unit 1c temporarily stores data to be processed by the processing device 3 among data received via the ports 1-1 through 1-n. The interface unit 1d enables access to the memory unit 1c from the processing device 3.

An operation of the data transfer system shown in FIG. 1 is now described below. The following description is exemplarily directed to a case where data to be processed by the processing device 3 is input from NET#L and is output to NET#2.

Data from NET#1 is received via the port 1-1, and is temporarily stored therein. The switching unit 1a refers to the header of data stored in the port 1-1, and identifies the destination of the data. If data should be transferred to any of other NET#2 through NET#n, the switching unit 1a switches the data to the corresponding port via the bus 1b. If the data should be processed by the processing device 3, the switching unit 1a switches the data to the memory unit 1c via the bus 1b. In the example being now concerned, the data should be processed by the processing device 3. Thus, the switching unit 1a stores the data in the memory unit 1c.

When the data is stored in the memory unit 1c, the processing device 3 is notified of this event. Then, the processing device 3 accesses the switch device 1 via the bus 2.

The interface unit id enables the access to the data stored in the memory unit 1c. As a result, the processing device 3 can execute a process for the data stored in the memory unit 1c.

After the process is completed, the data stored in the memory unit 1c is transferred to the corresponding port by the switching unit 1a, and is then sent to NET#2.

When the switch device 1 as described above is implemented, data that needs to be processed by the processing device 3 among data received via the ports 1-1 through 1-n is temporarily stored in the memory unit 1c. Then, the process by the processing device 3 is allowed by the interface unit 1d in the state in which the data is stored in the memory unit 1c without transferring the data to a memory device connected to the bus 2. Thus, the switch device 1 enables the switching of data over the bus 2 to be omitted, so that the data switching process can be promptly executed.

Next, a description will be given of an embodiment of the present invention.

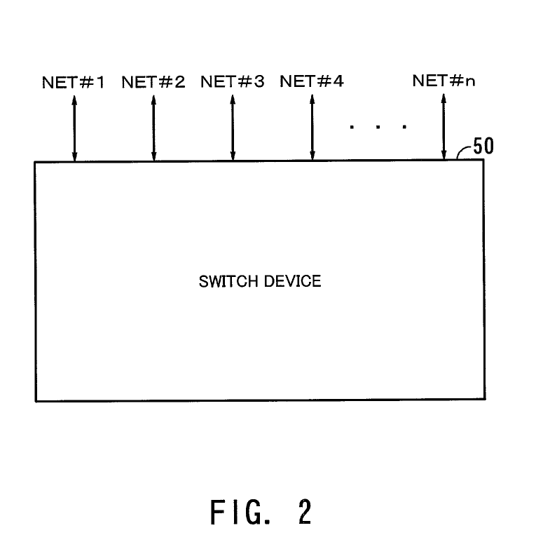

FIG. 2 is a diagram of a structure of an embodiment of the present invention. As shown in this figure, NET#1 through NET#n, which may be networks or network devices, are connected to a switch device 50 according to the present embodiment of the invention.

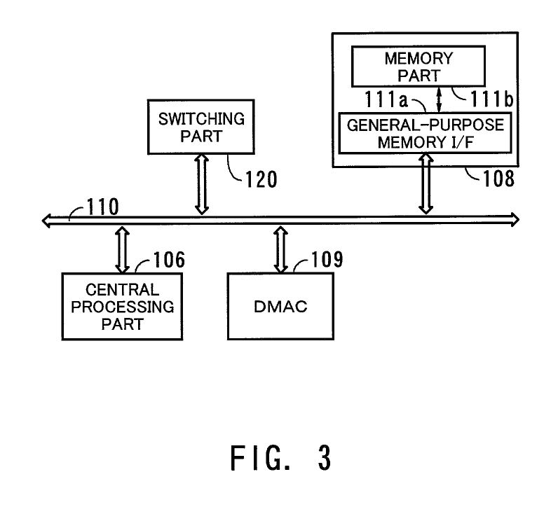

FIG. 3 is a block diagram of a typical example of the structure of the switch device 50. As shown in this figure, the switch device 50 is made up of a central processing part 106, a main memory part 108, a DMAC 109, an internal bus 110, and a switching part 120.

A plurality of terminals and networks are connected to the switching part 120, which executes a process of transferring data sent from a NET to another NET. The central processing part 106 executes various processes in accordance with programs stored in a memory part of the main memory part 108. Also, the central processing part 106 executes a process for communication data stored in a receiving RAM 533 (which will be described later) provided in the switching part 120. The main memory part 108 is made up of a general-purpose memory I/F 111a and a memory part 111b, and stores the programs executed by the central processing part 106. The DMAC 109 transfers data between the switching part 120 and the main memory part 108 without the central processing part 106. The internal bus 110 mutually connects the central processing part 106, the main memory part 108, the DMAC 109 and the switching part 120, and data can be transferred between these components.

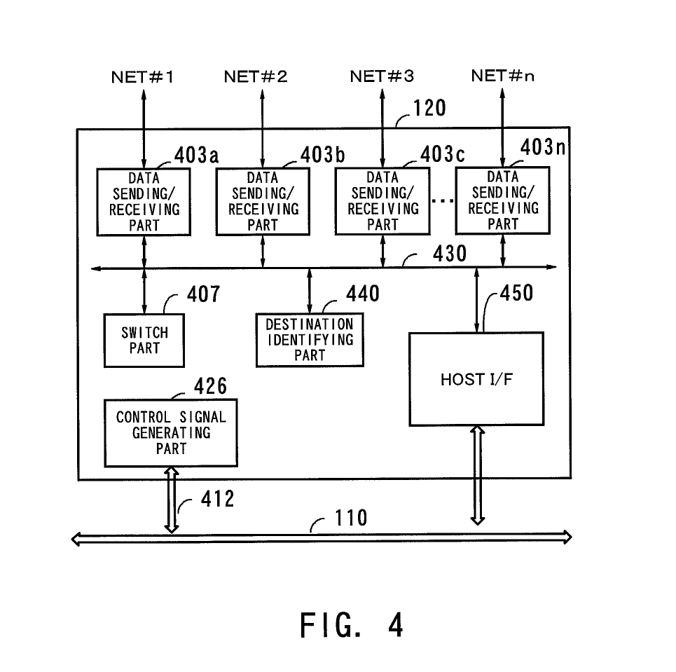

FIG. 4 is a block diagram of a typical example of the structure of the switching part 120. As shown in this figure, the switching part 120 is made up of data sending/receiving parts 403a through 403n, a host I/F 450, a switch part 407, a destination identifying part 440, and a control signal generating part 426.

The data sending/receiving parts 403a through 403n are respectively connected to NET#1 through NET#n, which are networks (or network devices), and send and receive data to and from the NET#1 through NET#n. The host I/F 450 temporarily stores data from the switch part 407, and allows access from the central processing part 106. The switch part 407 transfers data to the data sending/receiving part or the host I/F 450 in accordance with the destination decided by the destination identifying part 440. The control signal generating part 426 generates a control signal that instructs the DMAC 109 to transfer data when a transfer of data is needed. The destination identifying part 440 refers to the header of the data stored in the data sending/receiving part 403, and identifies the destination of transfer of data.

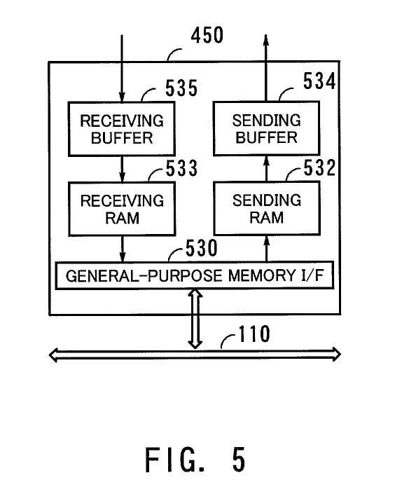

FIG. 5 is a block diagram of a typical example of the structure of the host I/F 450. As shown in this figure, the host I/F 450 is made up of a receiving buffer 535, a receiving RAM 533, a sending buffer 534, a sending RAM 532, and a general-purpose memory I/F530.

The receiving buffer 535 temporarily stores data supplied from the switch part 407, and then supplies it to the receiving RAM 533. The receiving RAM 533 temporarily stores data supplied from the receiving buffer 35 in order to have the data processed by the central processing part 106. The sending RAM 532 temporarily stores data to be sent to another NET (not filtered) among data that have been processed in the receiving RAM 533, and transfers the data to the sending buffer 534. The sending buffer 534 temporarily stores data stored in the sending RAM 532, and outputs it via the internal bus 430. The general-purpose memory I/F 530 enables access to the data stored at a given address of the receiving RAM 533, the access being issued by the central processing part 106.

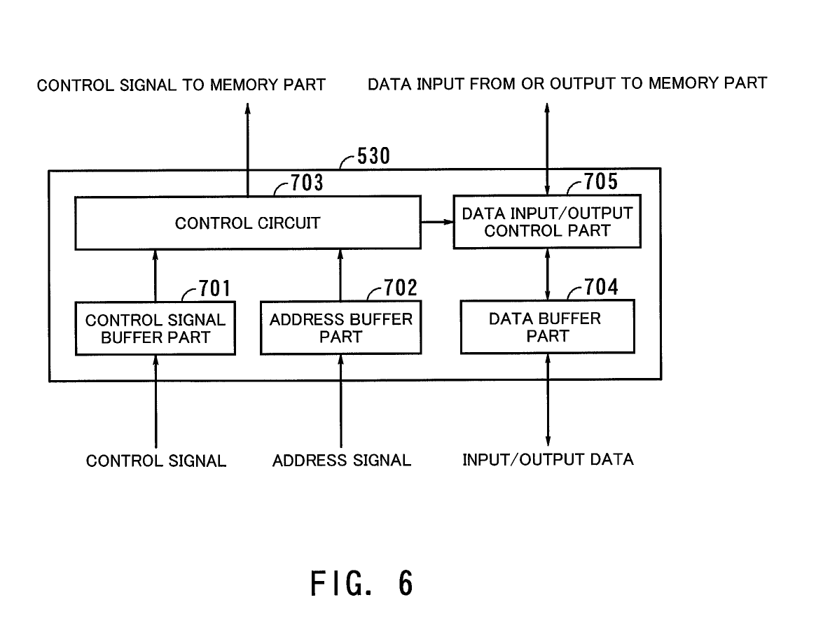

FIG. 6 is a block diagram of a typical example of the structure of the general-purpose memory I/F 530. As shown in this figure, the general-purpose memory I/F 530 is made up of a control signal buffer part 701, an address buffer part 702, a control circuit 703, a data buffer part 704, and a data input/output control part 705.

The control signal buffer part 701 performs a waveform shaping process for the control signal supplied over the internal bus 110, and outputs a resultant signal. The address buffer part 702 decodes signals supplied from the control signal buffer part 701 and the address buffer part 702, and supplies a control signal to the receiving RAM 533 and the sending RAM 532. The data buffer part 704 performs a waveform shaping process for a data output signal to the internal bus 110, and performs another waveform shaping process for a data output signal supplied from the internal bus 110. The data input/output control part 705 supplies output data from the receiving RAM 533 and the sending RAM 532 to the data buffer part 704 on the basis of the control signal from the control circuit 703. Similarly, the data input/output control part 705 supplies data output from the data buffer part 704 to the receiving RAM 533 and the sending RAM 532 on the basis of the control signal from the control circuit 703.

A description will be given of an operation of the above-mentioned embodiment of the invention. In the following, a case will be described where data that is input from NET#1 should be processed in a given manner by the central processing part 106, and is sent to NET#3. The destination identifying part 440 refers to the header of the data stored in the data sending/receiving part 403a, and identifies the destination of the data. In the example being concerned, the host I/F 450 is designated as the destination. Thus, the destination identifying unit 440 notifies the switch part 407 of the host I/F 450 as the destination. The switch 407 acquires the data stored in the data sending/receiving part 403a, and on the basis of the notice from the destination identifying part 440, switches the data to the host I/F 450. The host I/F 450 temporarily stores the supplied data in the receiving buffer 535, and thereafter stores it in the receiving RAM 533.

After the data is stored in the receiving RAM 533 by the above-mentioned manner, the control signal generating part 426 generates a control signal that instructs the central processing part 106 to initiate the data process, and sends the control signal to the central processing part 106 via the internal bus 110. In response to the control signal, the central processing part 106 accesses the host I/F 450. The access is given to the control signal buffer part 701 and the address buffer part 702 of the general-purpose memory I/F 530. Then, the access thus processed is sent to the control circuit 703.

The control circuit 703 accesses data stored in the receiving RAM 533. The address buffer part 702 has been supplied with a signal designating the address of the receiving RAM 533 at which the data is stored. The above address signal is decoded by the control circuit 703, and is supplied to the receiving RAM 533. Thus, the data is read from the designated address of the receiving RAM 533, and is supplied to the data buffer part 704 via the data input/output control part 705. The data is buffered by the data buffer part 704, and is supplied to the central processing part 106, which processes the data in a given manner. Examples of the process by the central processing part 106 are a header recalculation process and a discarding process.

When a process executed by the central processing part 106 other than the discarding process is completed, the data is stored in the sending RAM 532 via the general-purpose memory I/F 530. More particularly, the central processing part 106 supplies the general-purpose memory I/F 530 with a control signal for a data write and a signal that designates an address at which the data should be written. After completing the address designation, the central processing part 106 supplies the sending RAM 532 with the data that has been processed. In contrast, if the discarding process is performed, the data is not supplied to the sending RAM 532 but is discarded.

The general-purpose memory I/F 530 receives the control signal via the control signal buffer part 701, and supplies it to the control circuit 703. The control circuit 703 requests the sending RAM 532 to write data at the given address, and then writes the data supplied from the data input/output control part 705 at the designated address. The data written into the sending RAM 532 is transferred to the sending buffer 534 and is stored therein. The destination identifying part 440 identifies the destination of the data transferred to the sending buffer 534. The switch part 407 supplies the data to the data sending/receiving part corresponding to the identified destination. In the example being considered, since the destination is NET#3, the data is supplied to the data sending/receiving part 403c. The data sending/receiving part 403c sends the supplied data to NET#3.

By the above-mentioned process, the central processing part 106 processes the data input from NET#1, and sends the processed data to NET#3. In the above process, data that is to be processed by the central processing part 106 is processed in the state in which the data is stored in the receiving RAM 533 provided in the host I/F 450 without transferring the data to the main memory part 108. It is therefore possible to omit the process of transferring the data to the main memory part 108 under the control the DMAC 109, processing the data thus stored, and transferring the processed data from the main memory part 108 under the control of the DMAC 109. Thus, the process by the central processing part 106 can be executed promptly. It is also possible to shorten the time necessary for bus arbitration because of omission of the transfer process by the DMAC 109.

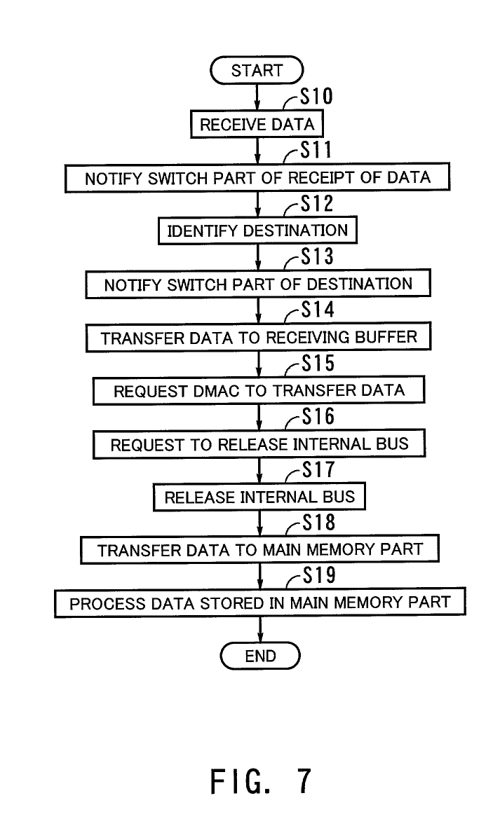

Next, a description will be given, with reference to FIGS. 7 through 10, of a data receiving and a sending process by the conventional switch device and a data receiving and a sending process by the present embodiment of the invention.

FIG. 7 is a flowchart of a data receiving process by the conventional switch device. After the flowchart is started, the following steps are executed. In the following, a case is exemplarily described where the data sending/receiving part 403a receives data that needs the process by the central processing part 106 from NET#1.

Step S10: The data sending/receiving part 403a receives data from NET#1.

Step S11: The data sending/receiving part 403a notifies the switch part 407 of receipt of data.

Step S12: The destination identifying part 440 refers to the header of the data stored in the data sending/receiving part 403a, and identifies the destination of the data.

Step S13: The destination identifying part 440 notifies the switch part 407 of the destination identified in step S12.

Step S14: The switch part 407 transfers the data from the data sending/receiving part 403a to the receiving buffer 525 in the host I/F 405 via the internal bus 430.

Step S15: The control signal generating part 426 notifies the DMAC 109 of the presence of data to be transferred by means of a control signal 412.

Step S16: The DMAC 109 requests the central processing part 106 to release the internal bus 110.

Step S17: The central processing part 106 releases the internal bus 110 when using the same.

Step S18: The DMAC 109 sequentially transfers the received data from the receiving buffer 525 in the host I/F 405 to the main memory part 108 via the input/output I/F 520.

Step S19: The central processing part 106 processes the data stored in the main memory part 108.

By the above process, the data that is input from the data sending/receiving part 403a is transferred to the main memory part 108 and is processed in the predetermined way.

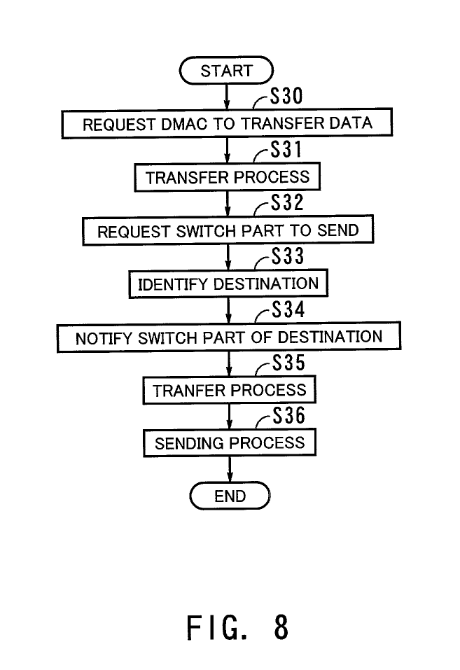

Next, a description will be given, with reference to FIG. 8, of a process of sending the data that is received and processed by the process shown in FIG. 7. In the following, a case is exemplarily described where the received data is sent by the data sending/receiving part 403c.

Step S30: The central processing part 106 notifies the DMAC 109 of the presence of data to be sent.

Step S31: The DMAC 109 sequentially reads the data designated by the central processing part 106 from the main memory part 108, and transfers the read data to the switching part 101 via the internal bus 110. The data thus transferred is stored in the sending buffer 524 via the input/output I/F 520 in the host I/F 405.

Step S32: The host I/F 405 notifies the switch part 407 of the presence of data to be sent.

Step S33: The host I/F 405 refers to information from the central processing part 106, and identifies the destination of data.

Step S34: The host I/F 405 notifies the switch part 407 that the destination is the data sending/receiving part 403c.

Step S35: The switch part 407 transfers the data from the sending buffer 524 to the data sending/receiving part 403c.

Step S36: The data sending/receiving part 403c sends the received data to NET#3.

By the above process, data stored in the main memory part 108 can be sent to NET#3.

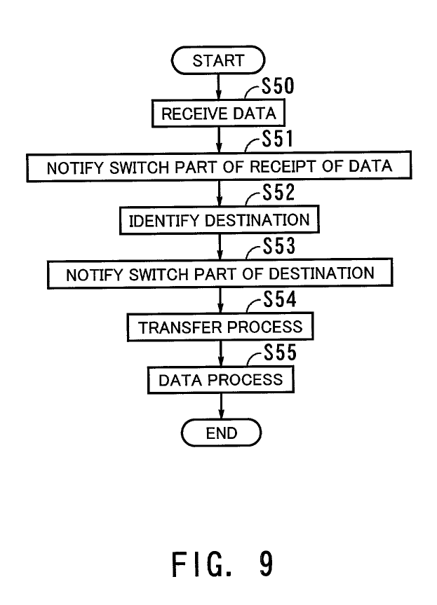

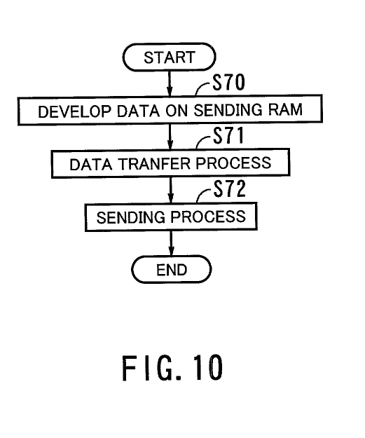

Next, a description will be given, with reference to FIGS. 9 and 10, of a data receiving and a sending process in the present embodiment of the invention. In the following, a case is exemplarily described where data received from NET#1 is processed by the central processing part 106.

Step S50: The data sending/receiving part 403a receives data from NET#1.

Step S51: The data sending/receiving part 403a notifies the switch part 407 of receipt of data.

Step S52: The destination identifying part 440 refers to the header of the data stored in the data sending/receiving part 403a, and recognizes that the destination is the host I/F 450.

Step S53: The destination identifying part 440 notifies the switch part 407 that the destination is the host I/F 450.

Step S54: The switch part 407 sequentially transfers the data from the data sending/receiving part 403a to the receiving buffer 535 in the host I/F 450 via the internal bus 430. The data stored in the receiving buffer 535 is transferred to the receiving RAM 533.

Step S55: The central processing part 106 accesses the data stored in the receiving RAM 533 via the general-purpose memory I/F 530, and processes the data.

Next, a description will be given, with reference to FIG. 10, of a data sending process in the present embodiment of the invention. In the following, a case is exemplarily described where data developed in the sending RAM 532 is sent from the data sending/receiving part 403c.

Step S70: The central processing part 106 develops data to be sent on the sending RAM 532. That is, the central processing part 106 stores, in the sending RAM 532, data that has been handled by a process other than the discarding process among the data that have been completely processed in the aforementioned step S55.

Step S71: The switch part 407 transfers the data stored in the sending RAM 532 to the data sending/receiving part 403c via the sending buffer 534 and the internal bus 430.

Step S72: The data sending/receiving part 403c sends the transferred data to NET#3.

By the above process, data stored in the host I/F 450 can be sent toward NET#3 from the data sending/receiving part 403c.

As described above, it can be seen from comparison between the sending and receiving process of the conventional switch device and that of the present embodiment of the invention that the same process can be executed by a smaller number of steps by the switch device of the embodiment and hence the process speed can be improved.

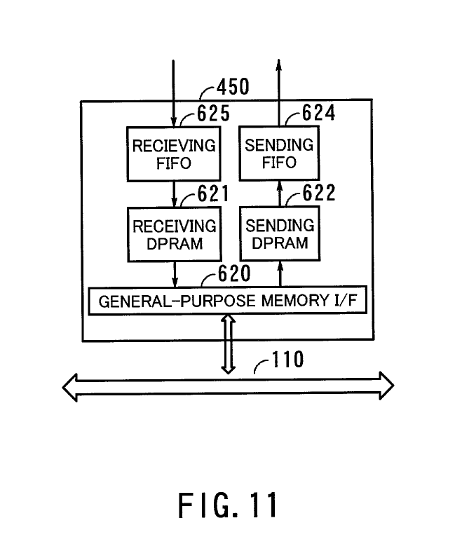

FIG. 11 is a block diagram of another structure of the host I/F 450 shown in FIG. 4. In this structure, the host I/F 450 is made up of a general-purpose memory I/F 620, a receiving DPRAM (Dual Port RAM) 621, a sending DPRAM 622, a sending FIFO 624, and a receiving FIFO 625.

The general-purpose memory I/F 620 is configured as shown in FIG. 6, and provides an interface for transferring data between the internal bus 110 and the receiving DPRAM 621 or the sending DPRAM 622. The receiving DPRAM 621 temporarily stores data that needs to be processed or has been processed by the central processing part 106. The dual-port structure of the receiving DPRAM 621 allows simultaneous accesses from both the receiving FIFO 625 and the general-purpose memory I/F 620.

The sending DPRAM 622 is used to temporarily store data that has been processed by the central processing part 106. Since the sending DPRAM 622 has a dual-port structure, it can be simultaneously accessed from both the sending FIFO 624 and the general-purpose memory I/F 620.

The sending FIFO 624 reads data stored in the sending DPRAM 622, and temporarily stores the read data. Then, data is read in the order in which the data was stored and is output to the internal bus 430. The receiving FIFO 625 temporarily stores data supplied from the switch part 407. Then, data is supplied to the receiving DPRAM 621 in the order in which the data was stored.

By employing DPRAMs to form the receiving and sending RAMs, it is possible to perform the write and read operations on the RAM in parallel. It is therefore possible to shorten the total processing time and thus execute the data transfer process promptly.

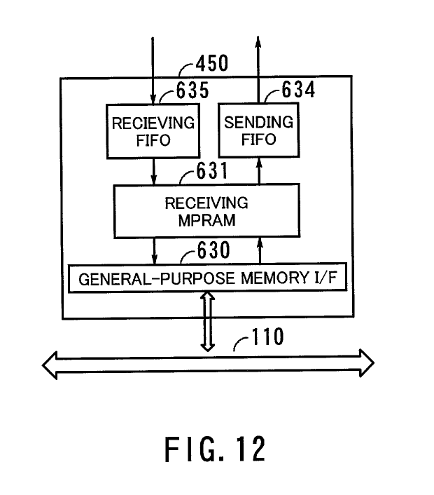

FIG. 12 is a block diagram of yet another structure of the host I/F 450 shown in FIG. 4. The host I/F 450 shown in this figure is made up of a general-purpose memory I/F 630, a sending/receiving MPRAM (Multi-Port RAM) 631, a sending FIFO 634, and a receiving FIFO 635.

The general-purpose memory I/F 630 is configured as shown in FIG. 6, and provides an interface for transferring data between the sending/receiving MPRAM 631 and the internal bus 110. The sending/receiving MPRAM 631 temporarily stores data that needs to be processed or has been processed by the central processing part 106. A multi-port structure of the MPRAM 631 allows simultaneous accesses by the sending FIFO 634, the receiving FIFO 635 and the general-purpose memory I/F 630. The sending FIFO 634 reads data stored in the sending/receiving MPRAM 631 and temporarily stores the read data. Then, the data is read in the order in which the data was stored, and is output to the internal bus 430. The receiving FIFO 635 temporarily stores data supplied from the switch part 407, and supplies the data to the sending/receiving MPRAM 631 in the storing order.

As described above, the receiving DPRAM 621 and the sending DPRAM 622 are integrated into the sending/receiving MPRAM 631. This results in omission of step S70 in the case where the central processing part 106 processes the received data supplied from the switch part 407 and sends the processed data to any of NET#1 through NET#n. Thus, the efficiency of processing can further be improved.

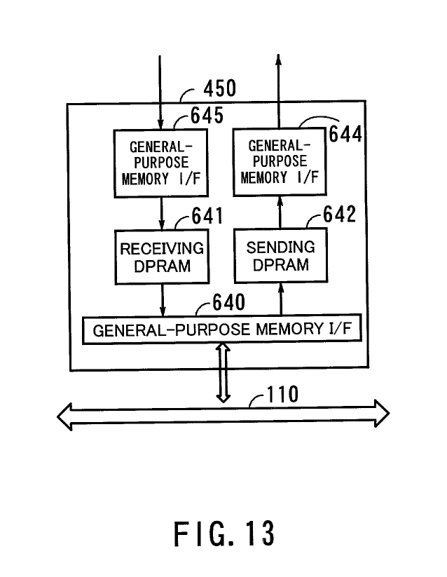

FIG. 13 is a block diagram of a further structure of the host I/F 450 shown in FIG. 4. The host I/F 450 shown in this figure is made up of a general-purpose memory I/F 640, a receiving DPRAM 641, a sending DPRAM 642, a general-purpose memory I/F 644, and a general-purpose memory I/F 645.

The general-purpose memory I/F 640 is configured as shown in FIG. 6, and provides an interface for transferring data between the internal bus 110 and the receiving DPRAM 641 or sending DPRAM 642. The receiving DPRAM 641 temporarily stores data that needs to be processed or has been processed by the central processing part 106. A dual-port structure of the receiving DPRAM 641 allows simultaneous accesses from both the general-purpose memory I/F 645 and the general-purpose memory I/F 640. The sending DPRAM 642 temporarily stores data that has been processed by the central processing part 106. A dual-port structure of the sending DPRAM 642 allows simultaneous accesses from both the general-purpose memory I/F 645 and the general-purpose memory I/F 640.

The general-purpose memory I/F 644 provides an interface that allows the switch part 407 to access an arbitrary address of the sending DPRAM 642, and is configured as shown in FIG. 6. Similarly, the general-purpose memory I/F 645 provides an interface that allows the switch part 407 to access an arbitrary address of the receiving DPRAM 641, and is configured as shown in FIG. 6.

By employing DPRAMs to form the receiving and sending RAMs, it is possible to perform the write and read operations on the RAM in parallel. It is therefore possible to shorten the total processing time and thus execute the data transfer process promptly. In addition, the use of the general-purpose memory I/F 644 and the general-purpose memory I/F 645 allows the switch part 407 to access data arbitrarily. Thus, data may be processed in priority order.

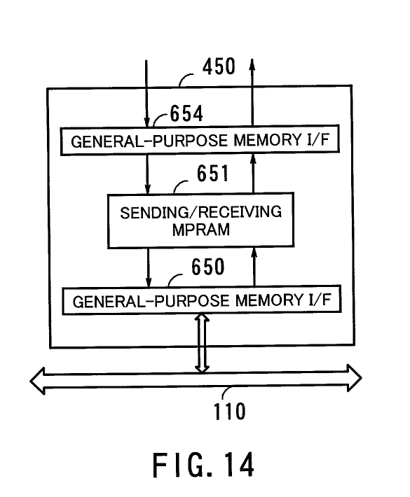

FIG. 14 is a block diagram of a still further structure of the host I/F 450 shown in FIG. 4. The host I/F 450 shown in this figure is made up of a general-purpose memory I/F 650, a sending/receiving MPRAM 651, and a general-purpose memory I/F 654.

The general-purpose memory I/F 650 is configured as shown in FIG. 6, and provides an interface for transferring data between the sending/receiving MPRAM 651 and the internal bus 110. The sending/receiving MPRAM 651 temporarily stores data that needs the process by the central processing part 106. A multi-port structure of the MPRAM 651 allows simultaneous accesses from the general-purpose memory I/F 654 and the general-purpose memory I/F 650. The general-purpose memory I/F 654 provides an interface that allows the switch part 407 to access arbitrary data stored in the sending/receiving MPRAM 651.

The receiving DPRAM 621 and the sending DPRAM 622 are integrated into the sending/receiving MPRAM 651 in the above-mentioned manner. This results in omission of step S70 in the case where the central processing part 106 processes the received data supplied from the switch part 407 and sends the processed data to any of NET#1 through NET#n. Thus, the efficiency of processing can further be improved. By employing the general-purpose memory I/F 654, it is possible for the switch part 407 to access arbitrary data and to thus implement priority-based data control with ease.

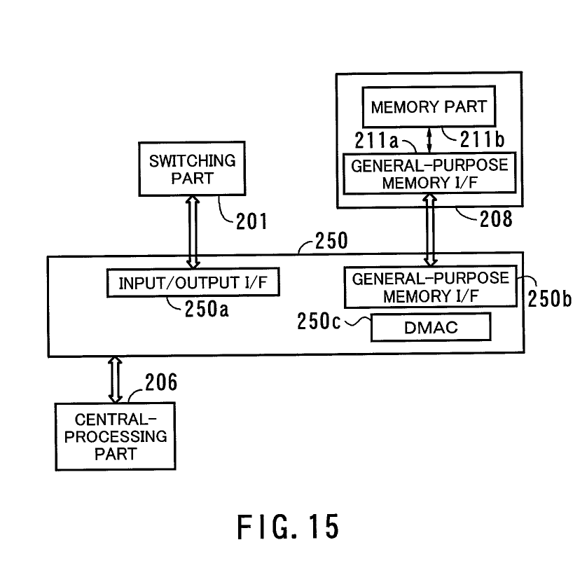

FIG. 15 is a block diagram of another structure of the switch device of the present invention. The switch device shown in FIG. 15 includes a bridge part 250 in addition to the aforementioned switching part 201, the central processing part 206 and the main memory part 208.

The switching part 201, which is configured as shown in FIG. 4, switches data that are received via NET#1 through NET#n and allows an access from the central processing part 206. The main memory part 208 is made up of a general-purpose I/F 211a and a memory part 211b, and stores programs executed by the central processing part 206. The central processing part 206 executes various processes in accordance with the programs stored in the memory part 211b, and processes communication data stored in the receiving RAM 533 in the switching part 201 in a given manner.

The bridge part 250 is made up of an input/output I/F 250a, a general-purpose memory I/F 250b, and a DMAC 250c, and mutually connects the switching part 201, the central processing part 206 and the main memory part 208 so as to transfer data between these components and to convert and arbitrate control signals.

The input/output I/F 250a provides an interface for connecting the switching part 201. The general-purpose memory I/F 250b provides an interface for connecting the main memory part 208, and is configured as shown in FIG. 6. The DMAC 250c has a function of transferring data between the switching part 201 and the main memory part 208.

The above-mentioned structure shown in FIG. 15 is the same as that shown in FIG. 3 except that the bridge part 250 is substituted for the internal bus 110, and the operation of the structure shown in FIG. 15 is basically the same as that of the structure shown in FIG. 3. Thus, a detailed description of the operation will be omitted here.

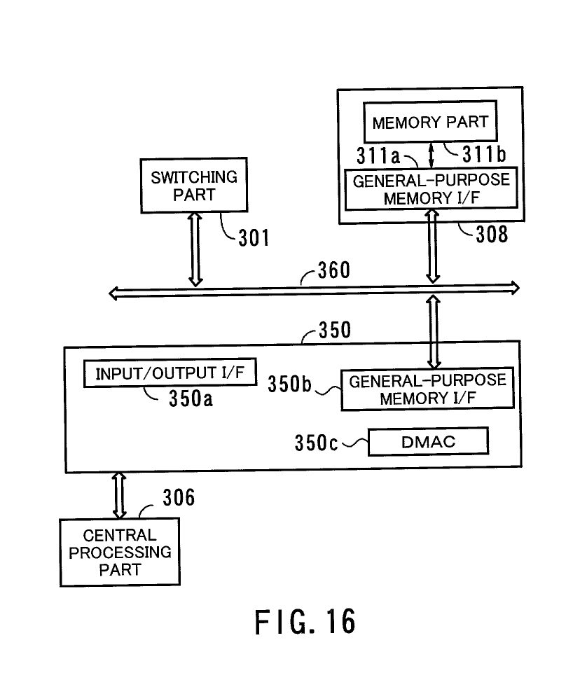

FIG. 16 is a block diagram of yet another structure of the switch device of the present invention. The structure shown in this figure is made up of a switching part 301, a central processing part 306, a main memory part 308, and the bridge part 350.

The switching part 301, which is configured as shown in FIG. 4, switches data that are input via NET#1 through NET#n, and allows an access from the central processing part 306. The main memory part 308 is composed of a general-purpose memory I/F 311a and a memory part 311b, and stores programs executable by the central processing part 306. The central processing part 306 executes various processes in accordance with the programs stored in the memory part 311b of the main memory part 308, and processes communication data stored in the receiving RAM 533 in the switching part 301 in a given manner.

The bridge part 350 mutually connects the switching part 301, the main memory part 308 and the central processing part 306 via the internal bus 360 so as to transfer data between these components and to convert and arbitrate control signals. The input/output I/F 350a provides an interface for making a connection to a given device that is not shown. The general-purpose memory I/F 350b connects the main memory part 308 and the switching part 301 via the internal bus 360. The DMAC 350c transfers data between the switching part 301 and the main memory part 308. The DMAC 350c may be omitted.

An operation of the structure shown in FIG. 16 will be described below.

When the switching part 301 receives data that needs to be processed by the central processing part 306, the switch part 407 transfers the received data to the receiving RAM 533. The central processing part 306 accesses, via the bridge part 350 and the internal bus 360, data in the receiving RAM 533 that should be processed. In this case, the main memory part 308, and the receiving RAM 533 and the sending RAM 532 in the switching part 301 are mapped in different areas of an identical memory space by the general-purpose I/F 350b. Thus, by designating the address of the receiving RAM 533 at which data is stored, the data can be accessed.

An access to the main memory part 308 can be made in the same manner as described above.

The data that has been processed by the central processing part 306 is transferred to the sending RAM 532 when it is sent to NET#1 through NET#n. Then, as has been described previously, the data is output via the corresponding data sending/receiving part.

According to the above-mentioned embodiment of the invention, the switching part 301 is equipped with the general-purpose memory I/F 530, and the receiving RAM 533 and the sending RAM 532 can make random access. These RAMs can be mapped in different areas of the memory space together with the memory part 311b of the main memory part 308. An arbitrary address is designated, so that data can be accessed arbitrarily.

Since the input/output I/F 350a may be released, another device can be connected here (a plurality of devices may also be connected). In addition, data transfer between the switching part 301 and the input/output I/F 350a may be omitted. Also, the input/output I/F 350a may be omitted, which results in downsizing of the device.

The above description of the embodiments of the invention supposes that data to be transferred is in the form of a packet with a header. However, the present invention is not limited to only data having such a format. Also, the present invention is not limited to the above-mentioned embodiments but includes other various embodiments.

Also, the switching part 120 shown in FIG. 3 may be in the form of LSIC (Large Scale Integrated Circuit), so that the switching part 120 can be formed as a one-chip semiconductor device.

The switching part 120 may be integrated with any of the central processing part 106, the DMAC 109 and the main memory part 108, so that a semiconductor device including these components can be formed.

In the aforementioned embodiments of the invention, received data is transferred, as one lump, to the host I/F 450 from the data sending/receiving part via the switch part 407. Similarly, data to be sent is transferred, as one lump, to the data sending/receiving part from the host I/F 450. However, as will be described below, data may be divided into parts, which are sequentially transferred.

More particularly, data that is being received by the data sending/receiving part is divided into parts, which are sequentially transferred to the switch part 407. When all parts of the data become available in the switch part 407, the data is transferred to the host I/F 450. Similarly, in the case of sending data, the host I/F 450 divides data that is being received from the internal bus 110 into parts, which are sequentially transferred to the switch part 407. When all parts of the data become available in the switch part 407, the data is transferred to the data sending/receiving part.

The above alternative may provide effects of the invention as described before.

In the aforementioned embodiments of the invention, the destination identifying part 440 identifies the destination of data that is stored in the data sending/receiving part (the host I/F 450 for sending). Alternatively, it is possible to refer to the header of data that is available on the internal bus 430 when the data is transferred to the switch part 450 from the data sending/receiving part (the host I/F 450 for sending).

Data transfer by the DMAC 109 may be initiated in the following manner if the receiving buffer 535 of the host I/F 450 has a sufficient capacity. The control signal generating part 426 notifies the DMAC 109 that data to be transferred is present in the main memory part 108 after a predetermined quantity of data becomes available in the receiving buffer 535 in the host I/F 450.

One example of the switch device according to the invention as described above includes: a plurality of ports; a switching part switching data received via the plurality of ports in accordance with destinations of the data; a memory part storing the data received from the plurality of ports; and an interface part enabling access to the memory part from a processing device that is provided outside of the switch device and processes the data stored in the memory part. Thus, data can be processed promptly.

One example of the data transfer system according to the invention includes a data transfer system comprising a switch device, and a data processing device, the switch device comprising: a plurality of ports for receiving and sending data; a switching part switching data received via the plurality of ports in accordance with destinations of the data; a memory part storing the data received via the plurality of ports; and an interface part enabling access to the memory part from the processing device that processes the data stored in the memory part. Thus, it is possible to prevent occurrence of loss of data due to a process delay caused in the processing device.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A switch device comprising:
a plurality of ports for receiving and sending data;
a switching part for switching data received via the plurality of ports in accordance with destinations of the data;
a memory part for storing the data received via the plurality of ports; and
an interface part for enabling access to said memory part from a processing device that is provided outside of the switch device and processes the data stored in the memory part.

2. The switch device according to claim 1, wherein said memory part comprises a first part for storing the data received from the plurality of ports, and a second part for storing data to be output to the plurality of ports.

3. The switch device according to claim 2, wherein the first and second parts of said memory part respectively comprise dual-port memories that allow simultaneous data writing and reading.

4. The switch device according to claim 1, wherein said memory part comprises a multi-port memory that allows simultaneous data writing, reading and accessing.

5. The switch device according to claim 1, wherein the processing device is connected to the switch device by a bus.

6. The switch device according to claim 1, wherein the processing device is connected to the switch device by a bridge.

7. A data transfer system comprising a switch device, and a data processing device, said switch device comprising:
a plurality of ports for receiving and sending data;
a switching part for switching data received via the plurality of ports in accordance with destinations of the data;
a memory part for storing the data received via the plurality of ports; and
an interface part for enabling access to said memory part from said processing device that processes the data stored in the memory part.

8. The data transfer system according to claim 7, wherein said memory part comprises a first part for storing the data received from the plurality of ports, and a second part for storing data to be output to the plurality of ports.

9. The data transfer system according to claim 8, wherein the first and second parts of said memory part respectively comprise dual-port memories that allow simultaneous data writing and reading.

10. The data transfer system according to claim 7, wherein said memory part comprises a multi-port memory that allows simultaneous data writing, reading and accessing.

11. The data transfer system as claimed in claim 7, further comprising a bus connecting said processing device and said switch device.

12. The data transfer system according to claim 7, further comprising a bridge connecting said processing device and said switch device.

13. The data transfer system according to claim 7, further comprising a memory device for storing a program executed by said processing device.
